(19) United States
(12) Patent Application Publication
(10) Pub. No.: US 2013/0290674 A1
(43) Pub. Date: Oct. 31, 2013

(54) Modeling Structured SIMD Control FLow Constructs in an Explicit SIMD Language

(71) Applicants: Biju George, San Jose, CA (US); Guei-Yuan Luch, San Jose, CA (US)

(72) Inventors: Biju George, San Jose, CA (US); Guei-Yuan Luch, San Jose, CA (US)

(21) Appl. No.: 13/459,574

(22) Filed: Apr. 30, 2012

(51) Int. Cl. G06F 9/30

(52) U.S. Cl. 712/201; 712/E09.016

(57) ABSTRACT

Constructs may express SIMD control flow that can be efficiently implemented on a SIMD machine with support for SIMD control flow. The execution semantics of constructs serve as a functional specification for an emulation implementation in the central processing unit (CPU), a non-SIMD machine, using conventional C++ compiler such as GCC or Microsoft Visual C++ without any modification to the conventional compiler in some embodiments.

### BACKGROUND

This relates particularly to graphics processing and, particularly, to programming languages for graphics processing.

In an explicit vector programming language, such as CM, the user explicitly indicates the desired level of data parallelism as opposed to having the computer or hardware compose the level of data parallelism based on scalar code written by the user.

The CM language specification is C++ with extended control flow constructs and semantics to express explicit data parallelism by means of operations on vector and matrix operands. CM is a specific instance of the class of explicit vector programming (or explicit data parallel) languages intended for a parallel single instruction multiple data (SIMD) machines. A control flow construct is used to execute one section of code one or more times based on a condition.

CM instructions generally require operands to have a consistent number of scalar elements which may or may not be contiguous. The number of scalar elements (also known as channels) computed by the instruction is the Single Instruction Multiple Data (SIMD) width. The SIMD width is statically determinable at compile-time.

Scalar control flow in CM is expressed by means of one of the following constructs—conditional statements (if-else/switch), loop statements (for/while), jump statements (break/continue/goto/return) or function calls. In scalar control flow, the control flow is uniform for all channels of instructions within control flow blocks; in other words control flow is channel independent. Instructions defined within scalar control flow blocks are not required to have a consistent SIMD width with respect to other instructions or conditions within the same scalar control flow block.

SIMD control flow differs from scalar control flow, in that with SIMD control flow the flow may be divergent for different channels of instructions within control flow blocks. In other words, control is defined on a per channel basis. Instructions defined within scalar control flow blocks are required to have a consistent SIMD width with respect to the SIMD block's associated SIMD condition.

### BRIEF DESCRIPTION OF THE DRAWINGS

Some embodiments are described with respect to the following figures:

FIG. 1 is a flow chart for a sequence for a break statement according to one embodiment;

FIG. 2 is a schematic diagram for a system according to one embodiment; and

FIG. 3 is a front elevational view of the system according to one embodiment.

### DETAILED DESCRIPTION

Constructs may express SIMD control flow that can be efficiently implemented on a SIMD machine with support for SIMD control flow. We formally define the execution semantics of these constructs. The execution semantics also serve as a functional specification for an emulation implementation in the central processing unit (CPU), a non-SIMD machine, using a conventional C++ compiler such as GCC or Microsoft Visual C++ without any modification to the conventional compiler in some embodiments.

Although the CM specification is used to express SIMD control flow, the same idea can be used to express any other language with an explicit vector programming model, such as EVA and Explicit language for Parallelism (ELF). SIMD control flow is expressed by means of predefined CM/C++ macros.

The predefined macros used to express SIMD control flow and their scalar equivalents (Scalar Equiv.) are shown in the table below.

| Type | SIMD Control Flow Macro | Scalar Equiv. |
|---|---|---|
| Conditional | SIMD_IF_BEGIN/SIMD_ELSE/SIMD_IF_END | if-else |
| Loop | SIMD_DO_WHILE_BEGIN/SIMD_DO_WHILE_END | do-while |
| Jump | SIMD-BREAK/SIMD_CONTINUE | break/continue |

The SIMD control flow statements allow the CM programmer to take advantage of the native SIMD control flow support.

In SIMD control flow statements, the condition is generally an SIMD (vector or matrix) condition in place of a scalar condition. Optionally the condition may also be a scalar if the SIMD control flow statement is nested in a SIMD control flow block. The SIMD width of a SIMD control flow block with a scalar condition is defined to be the SIMD width of its enclosing SIMD control flow block. A scalar condition is considered as a vector condition with size equal to the SIMD width and with all vector elements equal to the scalar condition.

SIMD control flow is defined on a per channel basis for all statements within a control flow block such that each channel may take independent control paths within the block. The control flow is thus stated to be divergent for different channels computed within the block. Generally the number of SIMD channels of statements within SIMD control flow blocks must correspond with the scalar size of the SIMD condition, in which case each scalar condition component associates to each corresponding statement channel. Optionally, scalar statements with a SIMD width of one are allowed, in which case the scalar condition associated with the scalar statements is determined to be true if any of the channels in the SIMD control flow block is active and false otherwise.

The example shown below shows the use of the SIMD control flow:

```
vector>int, 16>cond;
...
SIMD_IF_BEGIN (cond) {
...
} SIMD_ELSE {
    SIMD_IF_BEGIN (cond <0) {
        vector<int, 16>local;
        ...
        local = v.select<16, 1>(offset + offset y* sizex);
    }SIMD_ELSE {
    ...
    }SIMD_IF_END;
} SIMD_IF_END;
...
SIMD_DO_WHILE_BEGIN {
    vector<int, 16> local;
...
    SIMD_IF_BEGIN ((local<0) {
        SIMD_BREAK;
    }
...
}SIMD_DO_WHILE_END (cond < 32);
```

The following constraints may be placed on statements appearing within SIMD control flow blocks in order to guarantee consistent semantics and to allow for an efficient implementation in some embodiments:

1. The SIMD width of an SIMD control flow block may be a supported execution size by typical target architectures—typically a power of two greater than one and less than or equal to 32.

2. Nested SIMD control flow blocks must have the same SIMD width as their enclosing SIMD blocks. Thus the SIMD width of all nested SIMD control flow blocks is determined by the SIMD width of outermost SIMD control flow block.

3. All statements within a SIMD control flow block must either have their SIMD widths correspond to the SIMD width of its block, or must have a SIMD width equal to one. For statements that have destinations, requiring the statement to have a SIMD width equal to the SIMD width of its block implies that the destinations must be a vector/matrix of SIMD width elements; source expressions of statements may be either scalars of size one or vectors/matrices of SIMD width elements as permitted by the existing CM semantics.

4. Scalar control flow statements and conditional expressions are not permitted in SIMD control flow blocks. (One may use a scalar condition as a SIMD condition in a nested SIMD control flow block, but such a statement is still a SIMD control flow statement with the defined SIMD semantics).

5. Jump statements other than the SIMD_BREAK and SIMD_CONTINUE statements are not allowed in a SIMD control flow blocks. Likewise SIMD_BREAK and SIMD_CONTINUE statements are not allowed in a non-SIMD context.

6. Calling user-defined non-SIMD functions within an SIMD context is not permitted. There are no restrictions imposed on calling intrinsic functions provided none of the other constraints are violated.

7. If it is not possible to determine the SIMD width of a statement in a SIMD context, then that statement is considered illegal in an SIMD context. For example an statement such as (scalar1*scalar2) without a destination is considered illegal in SIMD context.

8. The source operand of a scalar reduction operator is required to have a size equal to the SIMD width of its immediate context. Furthermore, a reduction function will perform reduction only on active scalar sub-elements of its source as determined by its context's SIMD mask.

These semantics aid in justifying some of the constraints imposed. In order to define the behavior we define a pair of stacks—working SIMD mask stack and the break SIMD mask stack. The working SIMD mask stack is used to track the masks for active SIMD contexts; the top of the working SIMD mask stack is called the working SIMD mask. The break SIMD mask stack is for the purpose of describing the behavior of the SIMD loop statements. An additional Boolean variable, outerloop_simd_size_determined, initialized to “true” is used for the purposes of outer loop evaluation.

In order to simplify the definition, for conditional control statements with an if branch but without an else branch, then we will assume an empty else branch. Outermost SIMD control flow block contexts can be determined as contexts with the SIMD mask stack equal to one and outermost SIMD loop statement contexts can be determined as contexts with the SIMD break mask stack equal to one.

In general evaluation of SIMD sources of all instructions are subject to the working SIMD mask of its context; scalar sources are not subject to any mask. Note that a sub-expression evaluation from left to right is assumed for all expressions used in this section. We also assume that the macro definitions for SIMD control flow will call the function simd( ) on the SIMD condition for SIMD if and do-while statements.

The result of evaluation of the function simd( ) for a conditional/loop SIMD control statement is the result of evaluation of the boolean reduction function any( ) applied to the working SIMD mask after updating the working SIMD mask stack for the statement as described below.

During evaluation of the if branch of an outermost conditional SIMD control statement, the result of the evaluation of the statement's SIMD condition gets pushed on the working SIMD mask stack. After the evaluation of the if branch, the stack gets popped and the result of evaluation of the operation not (SIMD condition) gets pushed on the stack in preparation for evaluation of the else branch. After evaluation of the else branch the stack gets popped again and should be empty.

During evaluation of the if branch of a nested conditional SIMD control statement with a SIMD condition, the result of evaluation of the bitwise operator expression and (its SIMD condition, top (working SIMD mask stack)) gets pushed on the working SIMD mask stack. After the evaluation of the if branch the stack gets updated as and (not(pop(working SIMD mask stack)), top (working SIMD mask stack)), in preparation for evaluation of the else branch. After evaluation of the else branch the stack gets popped again.

During evaluation of the if branch of a nested conditional SIMD control statement with a scalar condition, the result of evaluation of the bitwise operator expression and (replicate(its scalar condition, width (top(working SIMD mask stack)))), top (working SIMD mask stack)) gets pushed on the working SIMD mask stack. After the evaluation of the if branch the stack gets updated as (not(pop(working SIMD mask stack)), top (working SIMD mask stack)), in preparation for evaluation of the else branch. After evaluation of the else branch the stack gets popped again.

The execution of SIMD if/else control flow statements is defined as follows. If any of the SIMD elements are active, that is if the function simd( ) evaluates to one, then the if branch is executed using calculated working SIMD mask for the branch, else the execution of the if branch is short-circuited. Prior to execution of the else branch after its SIMD mask has been calculated, if any of the SIMD elements are active, that is if the Boolean reduction function any( ) applied to the SIMD mask evaluates to one, then the else branch is executed, else the else branch is short-circuited.

Before the state of execution of an outermost SIMD control flow statement that is also a loop statement, a SIMD condition and mask of size 32 (maximum SIMD size permitted for SIMD control flow) indicating all elements are active is pushed on the working SIMD and break SIMD mask stack. Also the variable outloop_simd_size_determined is initialized to “false.” The evaluation of the first statement or SIMD condition in the loop with a SIMD width greater than one when outerloop_simd_size_determined is “false” will prune the SIMD condition and mask size to the SIMD width of the statement while preserving the unpruned values in them. The variable outloop_simd_size_determined is then again set to “true.” During evaluation of an outermost loop SIMD condition the result of evaluation of the bitwise operator expression and (its SIMD condition, top(break SIMD mask stack)) replaces the top of the working SIMD mask stack. After evaluation of the control statement, both the working SIMD mask stack and the break mask stack get popped. The variable outerloop_simd_size_determined is set to “false” after evaluation of an outermost loop.

Before the state of execution of a nested loop statement with a SIMD condition, a SIMD mask indicating all break elements are active is pushed on the break SIMD mask stack and the value of top(working SIMD mask stack) gets pushed on the working SIMD mask stack. During evaluation of a nested loop SIMD condition the result of evaluation of the bitwise operator expression and (and(its SIMD condition, top(break SMD mask stack)), top(working SIMD mask stack)) replaces the top of the working SIMD mask stack. After evaluation of the control statement, both the working SIMD mask stack and the break mask stack gets popped.

Before the state of execution of a nested loop statement with a scalar condition, a SIMD mask indicating all break elements are active is pushed on the break SIMD mask stack and the value of top(working SIMD mask stack) gets pushed on the working SIMD mask stack. During evaluation of a loop SIMD control statement with a scalar condition the result of evaluation of the bitwise operator expression and (and(replicate(its scalar condition, width (top(working SIMD mask stack))), top(break SIMD mask stack)), top(working SIMD mask stack)) replaces the top of the working SIMD mask stack. After evaluation of the control statement, both the working SIMD mask stack and the break mask stack gets popped.

The execution of SIMD do-while control flow statements is defined as follows. If any of the SIMD elements are active, that is if the function simd( ) evaluates to zero. However if the function simd( ) evaluates to zero, then the block is not executed at all.

Evaluation of a SIMD break statement (SIMD_BREAK) results in updating the values in the working SIMD mask stack. The working SIMD masks for all conditional statements up to the working SIMD mask for the nearest loop statement are updated on the working SIMD mask stack. Essentially all the active mask elements in the break statement immediate context are turned off for all the SIMD masks on the stack up to the working SIMD mask for nearest loop statement.

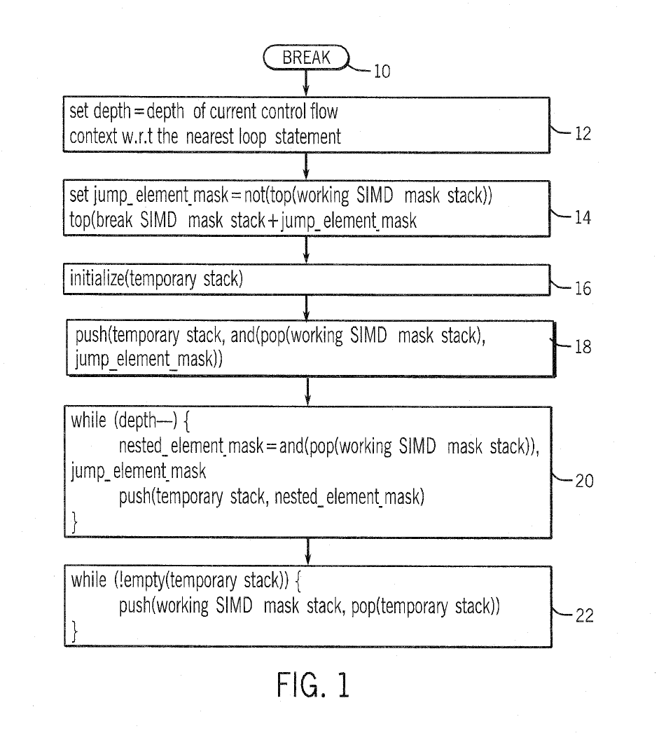

Referring to FIG. 1, a sequence may be implemented in firmware, software, and/or hardware. In software and firmware embodiments, the sequence may be implemented in computer executed instructions stored in a non-transitory computer readable medium, such as an optical, magnetic, or semiconductor storage.

The sequence 10 may begin by setting the depth equal to the depth of the current control flow context with respect to the nearest loop statement, as indicated in block 12. Then, in block 14, jump_element_mask is set equal to not(top(working SIMD mask stack)) and top(break SIMD mask stack+jump_element_mask). Then, the variable temporary stack is initialized, as indicated in block 16. Next, temporary stack and pop and (pop(working SIMD mask), jump_element_mask)) are pushed, as indicated in block 16. While depth is set, as indicated in block 20, nested_element_mask is set equal to and(pop(working SIMD mask stack)), jump_element_mask) and push(temporary stack, nested_element_mask), as indicated in block 20. Finally, in block 22, while temporary stack is empty, the working SIMD mask stack is pushed with respect to pop(temporary stack)).

This is described by the following pseudo code.

```
depth = depth of current control flow context with respect to the nearest
loop statement
jump_element_mask = not(top(working SIMD mask stack))
top(break SIMD mask stack + jump_element_mask
initialize(temporary stack)
push(temporary stack, and(pop(working SIMD mask stack),
jump_element_mask))
while (depth--) {
                    nested_element_mask = and(pop(working SIMD
                    mask stack)),
jump_element_mask)
                    push(temporary stack, nested_element_mask)
}
while(!empty(temporary stack)){
                    push(working SIMD mask stack,
                    pop(temporary stack))
}
```

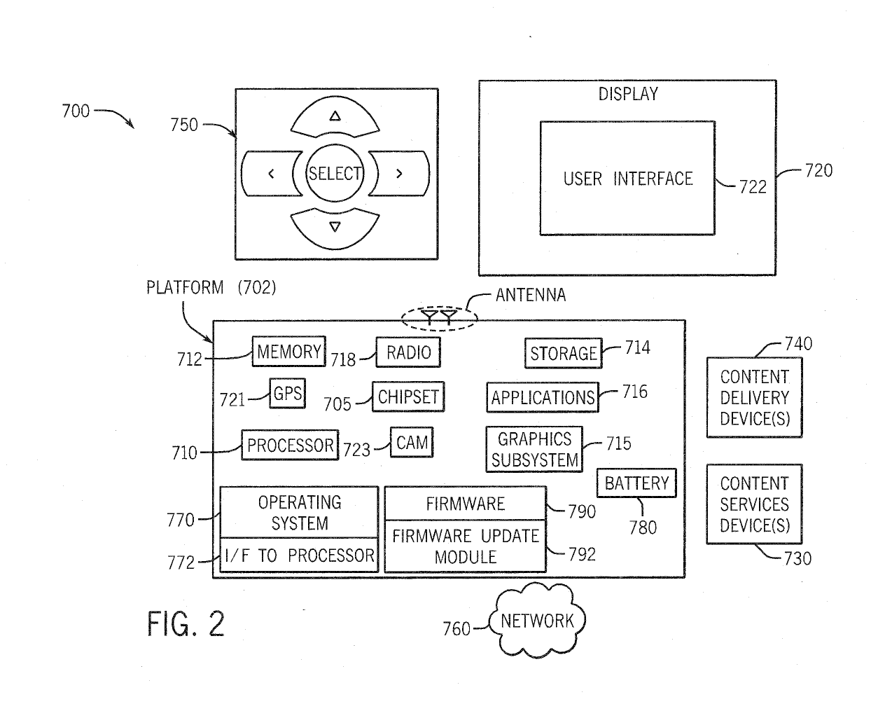

FIG. 2 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716, global positioning system (GPS) 721, camera 723 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

In addition, the platform 702 may include an operating system 770. An interface to the processor 772 may interface the operating system and the processor 710.

Firmware 790 may be provided to implement functions such as the boot sequence. An update module to enable the firmware to be updated from outside the platform 702 may be provided. For example the update module may include code to determine whether the attempt to update is authentic and to identify the latest update of the firmware 790 to facilitate the determination of when updates are needed.

In some embodiments, the platform 702 may be powered by an external power supply. In some cases, the platform 702 may also include an internal battery 780 which acts as a power source in embodiments that do not adapt to external power supply or in embodiments that allow either battery sourced power or external sourced power.

The sequence shown in FIG. 1 may be implemented in software and firmware embodiments by incorporating them within the storage 714 or within memory within the processor 710 or the graphics subsystem 715 to mention a few examples. The graphics subsystem 715 may include the graphics processing unit and the processor 710 may be a central processing unit in one embodiment.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone. Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 2.

As described above, system 700 may be embodied in varying physical styles or form factors. FIG. 2 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

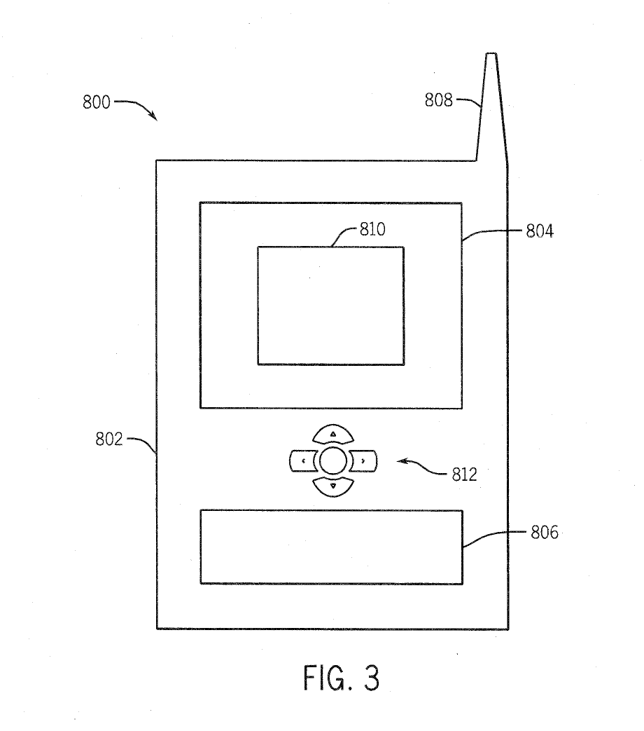

As shown in FIG. 3, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
modeling structured SIMD control flow constructs including break/continue statements in an explicit vector programming language.

2. The method of claim 1 including enabling programming in an explicit vector programming language to take advantage of native SIMD control flow support.

3. The method of claim 2 including making an SIMD width of an SIMD control block be a supported execution size.

4. The method of claim 2 including making the SIMD width of all nested SIMD control blocks equal to the SIMD width of an outermost SIMD control flow block.

5. The method of claim 2 including precluding scalar control flow statements in SIMD control flow blocks.

6. The method of claim 2 including excluding conditional expressions from SIMD control flow blocks.

7. The method of claim 2 including excluding jump statements other than SIMD_Break and SIMD continue from control flow blocks.

8. The method of claim 2 including precluding calling a user-defined function within an SIMD context.

9. The method of claim 2 including precluding statements in an SIMD context, which statements have an SIMD width that cannot be determined.

10. The method of claim 1 including making a source operand of a scalar reduction operator of a size equal to the SIMD width of its immediate context.

11. At least one non-transitory computer readable medium storing instructions to enable a processor to:
model structured SIMD control flow constructs including break/continue statements in an explicit vector programming language.

12. The medium of claim 11 further storing instructions to enable programming in an explicit vector programming language to take advantage of native SIMD control flow support.

13. The medium of claim 12 further storing instructions to make an SIMD width of an SIMD control block be a supported execution size.

14. The medium of claim 12 further storing instructions to make the SIMD width of all nested SIMD control blocks equal to the SIMD width of an outermost SIMD control flow block.

15. The medium of claim 12 further storing instructions to preclude scalar control flow statements in SIMD control flow blocks.

16. The medium of claim 12 further storing instructions to exclude conditional expressions from SIMD control flow blocks.

17. The medium of claim 12 further storing instructions to exclude jump statements other than SIMD_Break and SIMD continue from control flow blocks.

18. The medium of claim 12 further storing instructions to preclude calling a user-defined function within an SIMD context.

19. The medium of claim 12 further storing instructions to preclude statements in an SIMD context, which statements have an SIMD width that cannot be determined.

20. The medium of claim 11 further storing instructions to make a source operand of a scalar reduction operator of a size equal to the SIMD width of its immediate context.

21. An apparatus comprising:
a storage; and
a processor coupled to said storage to model structured SIMD control flow constructs including break/continue statements in an explicit vector programming language.

22. The apparatus of claim 21 said processor to program in an explicit vector programming language to take advantage of native SIMD control flow support.

23. The apparatus of claim 22 said processor to make an SIMD width of an SIMD control block be a supported execution size.

24. The apparatus of claim 22 said processor to make the SIMD width of all nested SIMD control blocks equal to the SIMD width of an outermost SIMD control flow block.

25. The apparatus of claim 22 said processor to preclude scalar control flow statements in SIMD control flow blocks.

26. The apparatus of claim 21 including a battery.

27. The apparatus of claim 26 including firmware and a module to update said firmware.
